(19) United States
(12) Patent Application Publication
(10) Pub. No.: US 2009/0135490 A1
(43) Pub. Date: May 28, 2009

(54) OPTICAL SHEET

(76) Inventors: Junghoon Lee, Cheongju (KR); Seungho Lee, Cheongju (KR)

Correspondence Address: BIRCH STEWART KOLASCH & BIRCH, PO BOX 747, FALLS CHURCH, VA, 22040-0747, US

(21) Appl. No.: 12/176,862

(22) Filed: Jul. 21, 2008

(30) Foreign Application Priority Data
Nov. 26, 2007 (KR) 10-2007-0121128

(51) Int. Cl. G02B 5/02

(52) U.S. Cl. 359/599

(57) ABSTRACT

An optical sheet is disclosed. The optical sheet includes a base film, a prism unit on the base film, an adhesive layer on the prism unit, and a first protective film on the adhesive layer. The prism unit is buried into the adhesive layer.

This application claims the benefit of Korean Patent Application No. 10-2007-0121128 filed on Nov. 26, 2007, which is hereby incorporated by reference.

### BACKGROUND

1. Field

An exemplary embodiment relates to an optical sheet including a protective film.

2. Description of the Related Art

Generally, a liquid crystal display (LCD) is an electric device that converts information for various electrical signals generated in various kinds of components using changes in a transmittance of a crystal liquid depending on an applied voltage into visual information and transfers the visual information.

Recently, a display field converting the information for the various electrical signals into the visual information is rapidly developing. Accordingly, flat panel display devices with excellent characteristics such as thin film, lightweight, low power consumption have been introduced. The flat panel display devices have rapidly replaced the existing cathode ray tubes and have been spotlighted.

Examples of the flat panel display devices may include a liquid crystal display (LCD), a plasma display panel (PDP), a field emission display (FED), and an electroluminescence display (ELD). Because the liquid crystal display has a high contrast ratio and an excellent performance to display a moving picture, the liquid crystal display is being briskly used in a display screen for notebook, a monitor, and a television.

The liquid crystal display may be classified as a light receiving display device. The liquid crystal display may include a liquid crystal panel displaying an image and a backlight unit that is positioned under the liquid crystal panel and provides light to the liquid crystal panel.

The backlight unit may include a light source providing light to the liquid crystal panel and an optical sheet. The optical sheet may include a diffusion sheet, a prism sheet, or a protective sheet.

In the related art backlight unit having the above-described configuration, light produced by the light source is diffused through optical films, namely, a diffusion sheet, and then can be focused by a prism sheet.

However, a damage such as scratch on the surface of the optical sheet may occur by an external pressure or a physical contact in a process for transferring or assembling each of the optical sheets.

### SUMMARY

An exemplary embodiment provides an optical sheet capable of preventing a damage to the surface of the optical sheet and easily attaching and tearing off a protective film.

In one aspect, an optical sheet comprises a base film, a prism unit on the base film, an adhesive layer on the prism unit, and a first protective film on the adhesive layer, wherein the prism unit is buried into the adhesive layer.

In another aspect, an optical sheet comprises a base film, a prism unit on the base film, a adhesive layer on the prism unit, and a first protective film on the adhesive layer, wherein a distance between one surface of the base film and a bottom surface of the adhesive layer is shorter than a distance between one surface of the base film and a peak of the prism unit.

### BRIEF DESCRIPTION OF TEE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 is a cross-sectional view of an optical sheet according to an exemplary embodiment;

FIGS. 2 to 5 show various shapes of a prism unit of the optical sheet according to the exemplary embodiment;

FIG. 6 is a diagram enlarging an area A of FIG. 1;

FIG. 7 shows an optical sheet according to another exemplary embodiment;

FIG. 8 is a diagram enlarging an area B of FIG. 7; and

FIGS. 9 to 12 show various implementations of an optical sheet.

### DETAILED DESCRIPTION OF EMBODIMENTS

Reference will now be made in detail embodiments of the invention examples of which are illustrated in the accompanying drawings.

An optical sheet comprises a base film, a prism unit on the base film, an adhesive layer on the prism unit, and a first protective film on the adhesive layer, wherein the prism unit is buried into the adhesive layer.

A buried depth of the prism unit into the adhesive layer may lie substantially in a range between 5% and 30% of a height of the prism unit.

A thickness of the adhesive layer may lie substantially in a range between 1 μm and 10 μm.

The prism unit may include a plurality of first beads.

The optical sheet may further comprise a second protective film under the base film.

The prism unit may include a plurality of peaks and a plurality of valleys, and a height of each peak varies randomly along a longitudinal direction on the prism unit.

The prism unit may include a plurality of peaks and a plurality of valleys, and the peak is formed in the form of a straight line or a curved line along a longitudinal direction of the prism unit.

The optical sheet may further comprise a protective layer under the base film.

The protective layer may include a plurality of second beads. The optical sheet may further comprise a reflective polarizing film under the base film.

The reflective polarizing film may include first layers and second layers alternately stacked on each other, and a refractive index of the first layer is different from a refractive index of the second layer.

An optical sheet comprises a base film, a prism unit on the base film, a adhesive layer on the prism unit, and a first protective film on the adhesive layer, wherein a distance between one surface of the base film and a bottom surface of the adhesive layer is shorter than a distance between one surface of the base film and a peak of the prism unit.

The optical sheet may further comprise a protective layer under the base film, the protective layer including a plurality of second beads.

The optical sheet may further comprise a reflective polarizing film under the base film, wherein the reflective polarizing film includes first layers and second layers alternately stacked on each other, and a refractive index of the first layer is different from that of the second layer.

A buried depth of the prism unit into the adhesive layer may lie substantially in a range between 5% and 30% of a height of the prism unit.

A thickness of the adhesive layer may lie substantially in a range between 1 μm and 10 μm.

The prism unit may include a plurality of first beads.

The optical sheet may further comprise a second protective film under the base film.

The prism unit may include a plurality of peaks and a plurality of valleys, and a height of each peak varies randomly along a longitudinal direction on the prism unit.

The prism unit may include a plurality of peaks and a plurality of valleys, and the peak is formed in the form of a straight line or a curved line along a longitudinal direction of the prism unit.

Hereinafter, exemplary embodiments will be described in detail with reference to the attached drawings.

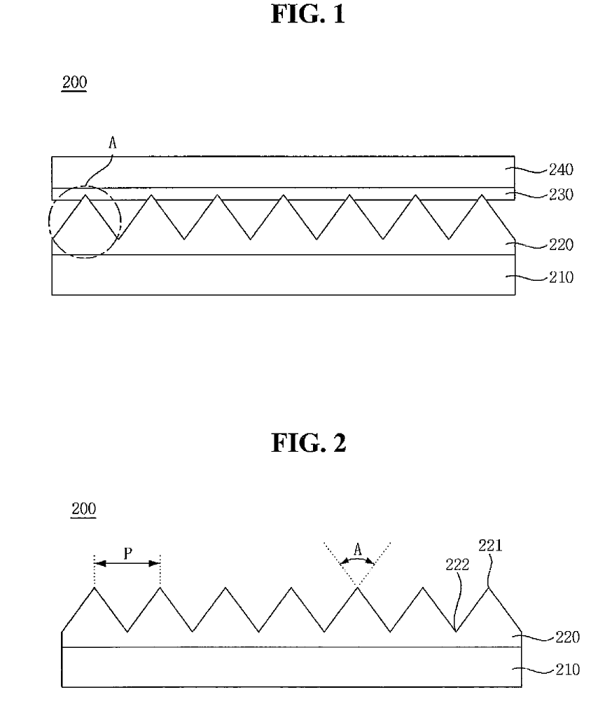

FIG. 1 is a cross-sectional view of an optical sheet according to an exemplary embodiment.

As shown in FIG. 1, an optical sheet 200 according to an exemplary embodiment includes a base film 210, a prism unit 220 on the base film 210, an adhesive layer 230 on the prism unit 220, and a first protective film 240 on the adhesive layer 230. The prism unit 220 may be buried into the adhesive layer 230.

More specifically, the base film 210 can transmit light produced by a light source. Therefore, the base film 210 may be made of a light transmission material capable of transmitting light, for example, any one of polyethylene terephthalate, polycarbonates, polypropylene, polyethylene, polystyrene, and polyepoxy, but is not limited thereto.

FIGS. 2 to 5 show various shapes of a prism unit of the optical sheet according to the exemplary embodiment;

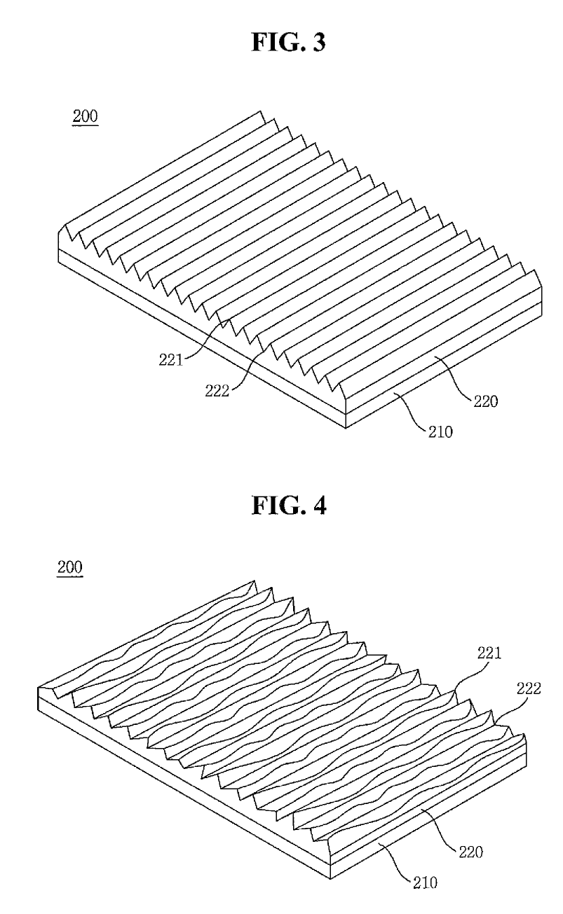

As shown in FIGS. 2 and 3, the prism unit 220 can focus the light produced by the light source. The prism unit 220 may be made of a transparent polymer resin so as to transmit light emitted from the outside. Examples of the transparent polymer resin may include acrylic resin, polycarbonates resin, polypropylene resin, polyethylene resin, and polyethylene terephthalate resin.

The prism unit 220 may have a triangle-shaped section. The prism unit 220 may include a plurality of peaks 221 and a plurality of valleys 222. The peaks 221 and the valleys 222 may extend along a longitudinal direction of the prism unit 220.

A distance P between the peaks 221 of the prism unit 220 may be 20 μm to 60 μm. An angle A of the peak 221 may be 70° to 110°. A height of the prism unit 220 may be 10 μm to 50 μm.

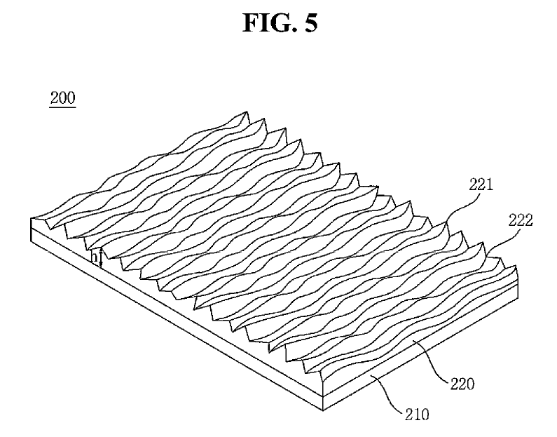

As shown in FIG. 4, the peaks 221 or the valleys 222 of the prism unit 220 may form a continuously curved line in the longitudinal direction of the prism unit 220. The curved line may be regular or irregular. More specifically, the peaks 221 of the prism unit 220 may be formed in a zigzag form in which right and left sides are random. An average horizontal amplitude of the peaks 221 may lie substantially in a range between 1 μm and 20 μm. Further, the valley 222 of the prism unit 220 may be formed in a zigzag form in which right and left sides are random. An average horizontal amplitude of the valley 222 may lie substantially in a range between 1 μm and 20 μm.

As shown in FIG. 5, a height h of the peak 221 of the prism unit 220 as measured from a bottom surface of the peak 221 may continuously change along a longitudinal direction of the prism unit 220. The peak 221 may form a regular or irregular curve. An average height difference between the heights of the peaks 221 may lie substantially in a range between 1 μm and 20 μm.

Referring again to FIG. 1, the adhesive layer 230 may be positioned on the prism unit 220. The adhesive layer 230 is used to attach the protective film to the prism unit 220. The adhesive layer 230 may use an acrylic-based resin.

The first protective film 240 may be positioned on the adhesive layer 230. The first protective film 240 can maintain a shape of the optical sheet 200 and prevent the optical sheet 200 from being damaged by a physical force from the outside.

The adhesive layer 230 on one surface of the first protective film 240 may be used so as to easily remove the first protective film 240 from the optical sheet 200 in a subsequent process for assembling a backlight unit.

The adhesive layer 230 may be coated on one surface of the first protective film 240 in a thickness of 1 μm to 10 μm. When the thickness of the adhesive layer 230 is equal to or larger than 1 μm, the adhesive layer 230 can be uniformly coated on one surface of the first protective film 240. When the thickness of the adhesive layer 230 is equal to or smaller than 10 μm, a problem caused by deeply burying the peak of the optical sheet 200 into the adhesive layer 230 can be prevented in a subsequent process for removing the first protective film 240 from the optical sheet 200.

A portion of the prism unit 220 may be buried into the adhesive layer 230.

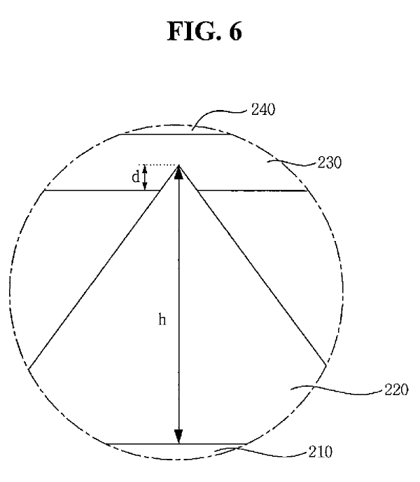

More specifically, the prism unit 220 may be buried into the adhesive layer 230 with reference to FIG. 6 enlarging an area A of FIG. 1.

When the first protective film 240 coated with the adhesive layer 230 is attached to the prism unit 220 after the optical sheet 200 is manufactured, the prism unit 220 may be buried into the adhesive layer 230 by applying a predetermined force to the first protective film 240.

A buried depth d of the prism unit 220 into the adhesive layer 230 may lie substantially in a range between 5% and 30% of a height of the prism unit 220. The height h of prism unit 220 is equal to a distance between the surface of the base film 210 and the peak 221. When the buried depth d of the prism unit 220 is equal to or larger than 5%, the first protective film 240 is not easily torn off by increasing an adhesive force between the optical sheet and the first protective film 240. When the buried depth d of the prism unit 220 is equal to or smaller than 30%, it is easy to perform the subsequent process for removing the first protective film 240 from the optical sheet 200.

As described above, the optical sheet is not deformed and can be protected from an external pressure by attaching the first protective film to one surface of the optical sheet and adjusting the buried depth of the prism unit into the adhesive layer. Further, the first protective film can be easily removed from the optical sheet.

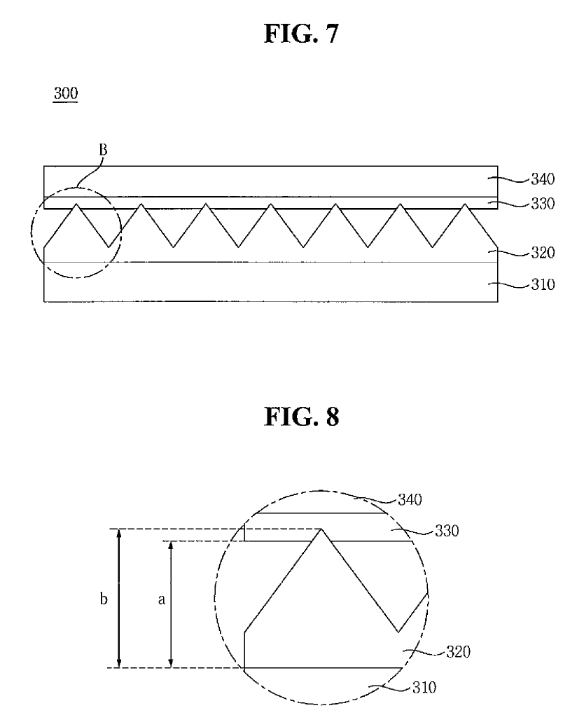

FIG. 7 shows an optical sheet according to another exemplary embodiment, and FIG. 8 is a diagram enlarging an area B of FIG. 7.

As shown in FIG. 7, an optical sheet 300 according to another exemplary embodiment includes a base film 310, a prism unit 320 on the base film 310, an adhesive layer 330 on the prism unit 320, and a first protective film 340 on the adhesive layer 330.

Since configurations of the base film 310, the prism unit 320, the adhesive layer 330, and the first protective film 340 shown in FIGS. 7 and 8 are the same as those shown in FIGS. 1 and 6, the description thereabout is briefly made or entirely omitted.

As shown in FIG. 8, a distance a between one surface of the base film 310 and a bottom surface of the adhesive layer 330 may be shorter than a distance b between one surface of the base film 310 and a peak of the prism unit 320. When the first protective film 340 coated with the adhesive layer 330 is attached to the prism unit 320 after the optical sheet 300 is manufactured, the prism unit 320 may be buried into the adhesive layer 330 by applying a predetermined force to the first protective film 340. Therefore, the distance a may be shorter than the distance b.

Because the distance a between one surface of the base film 310 and the bottom surface of the adhesive layer 330 is shorter than the distance b between one surface of the base film 310 and the peak of the prism unit 320, the first protective film 340 is not easily torn off by increasing an adhesive force between the first protective film 340 on the prism unit 320 and the optical sheet 300.

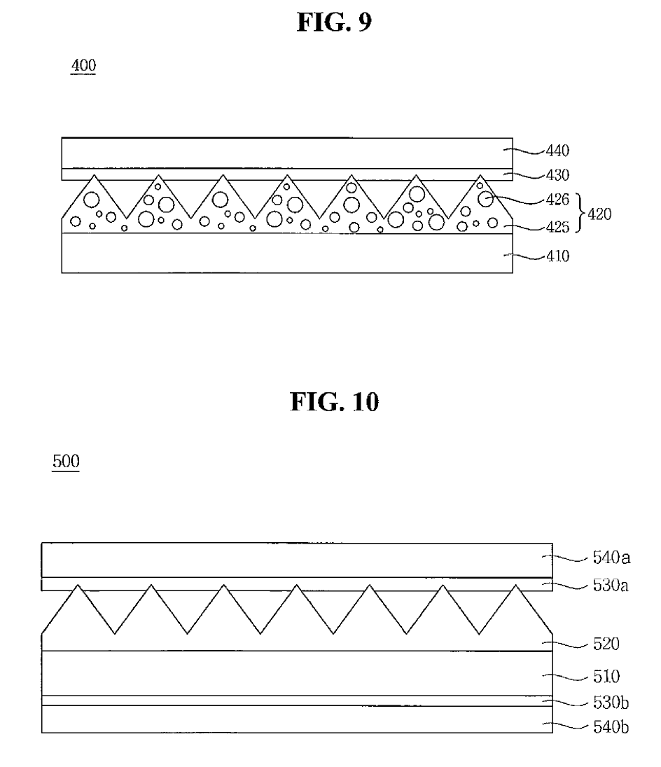

FIGS. 9 to 12 show various implementations of an optical sheet.

Since various implementations of an optical sheet that will be described later with reference to FIGS. 9 to 12 include the configuration of the above-described exemplary embodiments, the description thereabout is briefly made or entirely omitted.

As shown in FIG. 9, an optical sheet 400 may include a base film 410, a prism unit 420 on the base film 410, an adhesive layer 430 on the prism unit 420, and a first protective film 440 on the adhesive layer 430. The prism unit 420 may include a plurality of first beads 426.

More specifically, the prism unit 420 may include a resin 425 and the plurality of first beads 426. The resin 425 may be an acrylic resin. The first bead 426 may include polymethylmethacrylate (PMMA), polystyrene, and silicon.

The prism unit 420 may include about 1 to 10 parts by weight of the first bead 426 based on the resin 425. Particle diameters of the first beads 426 may be non-uniform.

A shape of the first bead 426 may be a circle, an oval, a shape like a snowman, and an uneven circle, but is not limited thereto.

The first beads 426 may be non-uniformly distributed inside the resin 425. All the first beads 426 may be distributed inside the resin 425 so as not to expose the first beads 426 on the surface of the prism unit 420.

A difference between a refractive index of the first bead 426 and a refractive index of the resin 425 may lie substantially in a range between 0.01 and 0.5. The difference between the refractive indexes can improve a diffusion characteristic of the optical sheet 400 by diffusing light and prevent a reduction in the amount of light traveling in the forward direction.

Accordingly, because the optical sheet 400 includes the plurality of beads 426 inside the prism unit 420, light produced by a light source can be diffused.

As shown in FIG. 10, an optical sheet 500 may include a base film 510, a prism unit 520 on one surface of the base film 510, an adhesive layer 530a on the prism unit 520, an adhesive layer 530b on the other surface of the base film 510, a first protective film 540a on the adhesive layer 530a, and a second protective film 540b on the adhesive layer 530b.

The second protective film 540b can maintain a shape of the optical sheet 500 and prevent the optical sheet 500 from being damaged by a physical force from the outside. Further, the adhesive layer 530b on the second protective film 540b may be used so as to easily remove the second protective film 540b from the optical sheet 500 in a subsequent process for assembling a backlight unit.

As described above, because the optical sheet 500 includes the second protective film 540b in addition to the first protective film 540a, the optical sheet 500 can be prevented from being damaged by a physical force from the outside.

As shown in FIG. 11, an optical sheet 600 may include a base film 610, a prism unit 620 on the base film 610, an adhesive layer 630 on the prism unit 620, and a first protective film 640 on the adhesive layer 630.

The optical sheet 600 may further include a protective layer 650 under the base film 610. The protective layer 650 may include a plurality of beads 652.

The protective layer 650 can improve thermal resistance of the optical sheet 600. The protective layer 650 may include a resin 651 and the plurality of second beads 652 distributed inside the resin 651.

The resin 651 may use a transparent acrylic-based resin with excellent thermal resistance and excellent mechanical characteristic. Examples of the acrylic-based resin may include polyacrylate or polymethylmethacrylate.

The second bead 652 may be made of the same material as the resin 651 or a different material from the resin 651. The protective layer 650 may include about 10 to 50 parts by weight of the second bead 652 based on the resin 651.

The size of the second bead 652 may depend on a thickness of the base film 610 and may lie substantially in a range between 1 μm to 10 μm.

The second beads 652 may have the substantially equal size and may be regularly distributed in the resin 651. Further, the second beads 652 may have a different size and may be irregularly distributed in the resin 651.

The second bead 652 may be the same as the first bead 426 shown in FIG. 9, and the second bead 652 may be different from the first bead 426.

The protective layer 650 can prevent the optical sheet 600 from being deformed by light produced by a light source. In other words, the protective layer 650 with high thermal resistance can prevent the optical sheet 600 from crumpling. Although the optical sheet 600 is deformed at a high temperature, the deformed optical sheet 600 can be restored to an original shape of the optical sheet 600 at a room temperature due to an excellent restoring force.

The protective layer 650 can prevent the optical sheet 200 from being damaged by an external impact or a physical force from the outside.

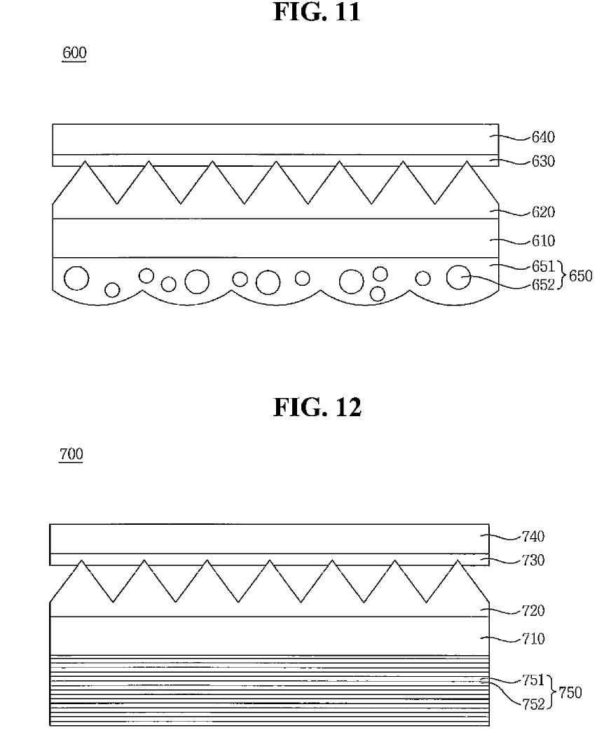

As shown in FIG. 12, an optical sheet 700 may include a base film 710, a prism unit 720 on one surface of the base film 710, an adhesive layer 730 on the prism unit 720, and a first protective film 740 on the adhesive layer 730. The optical sheet 700 may further include a reflective polarizing film 750 on the other surface of the base film 710.

The reflective polarizing film 750 can transmit and reflect light produced by a light source. The reflective polarizing film 750 may include a first layer 751 including a polymer and a second layer 752 adjacent to the first layer 751. The second layer 752 may include a polymer having a refractive index different from a refractive index of the polymer of the first layer 751.

The first layers 751 and the second layers 752 may be alternately stacked on each other. The first layer 751 may be made of polymethylmethacrylate (PMMA), and the second layer 752 may be made of Polyethylene Terephthalate (PET).

The reflective polarizing film 750 may have a thickness of 120 μm to 450 μm.

Accordingly, a portion of the light produced by the light source is transmitted by the reflective polarizing film 750, and a portion of the light is reflected from the reflective polarizing film 750 toward the light source under the reflective polarizing film 750. The light reflected toward the light source is again reflected and is incident on the reflective polarizing film 750. A portion of the light incident on the reflective polarizing film 750 transmits the reflective polarizing film 750, and a portion of the incident light is again reflected from the reflective polarizing film 750 toward the light source under the reflective polarizing film 750.

As described above, because the optical sheet 700 includes the reflective polarizing film 750 formed by alternately stacking the polymer layers each having a different refractive index on each other and using a principle in which a polarization of a different direction is transmitted and a polarization of the same direction is reflected by orienting molecules of the polymer in one direction, the efficiency of the light produced by the light source can be improved.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. An optical sheet comprising:
a base film;
a prism unit on the base film;
an adhesive layer on the prism unit; and
a first protective film on the adhesive layer,
wherein the prism unit is buried into the adhesive layer.

2. The optical sheet of claim 1, wherein a buried depth of the prism unit into the adhesive layer lies substantially in a range between 5% and 30% of a height of the prism unit.

3. The optical sheet of claim 2, wherein a thickness of the adhesive layer lies substantially in a range between 1 μm and 10 μm.

4. The optical sheet of claim 1, wherein the prism unit includes a plurality of first beads.

5. The optical sheet of claim 1, further comprising a second protective film under the base film.

6. The optical sheet of claim 1, wherein the prism unit includes a plurality of peaks and a plurality of valleys, and a height of each peak varies randomly along a longitudinal direction on the prism unit.

7. The optical sheet of claim 1, wherein the prism unit includes a plurality of peaks and a plurality of valleys, and the peak is formed in the form of a straight line or a curved line along a longitudinal direction of the prism unit.

8. The optical sheet of claim 1, further comprising a protective layer under the base film.

9. The optical sheet of claim 8, wherein the protective layer includes a plurality of second beads.

10. The optical sheet of claim 1, further comprising a reflective polarizing film under the base film.

11. The optical sheet of claim 10, wherein the reflective polarizing film includes first layers and second layers alternately stacked on each other, and a refractive index of the first layer is different from a refractive index of the second layer.

12. An optical sheet comprising:
a base film;
a prism unit on the base film;
a adhesive layer on the prism unit; and
a first protective film on the adhesive layer,
wherein a distance between one surface of the base film and a bottom surface of the adhesive layer is shorter than a distance between one surface of the base film and a peak of the prism unit.

13. The optical sheet of claim 12, further comprising a protective layer under the base film, the protective layer including a plurality of second beads.

14. The optical sheet of claim 12, further comprising a reflective polarizing film under the base film,
wherein the reflective polarizing film includes first layers and second layers alternately stacked on each other, and a refractive index of the first layer is different from that of the second layer.

15. The optical sheet of claim 12, wherein a buried depth of the prism unit into the adhesive layer lies substantially in a range between 5% and 30% of a height of the prism unit.

16. The optical sheet of claim 12, wherein a thickness of the adhesive layer lies substantially in a range between 1 μm and 10 μm.

17. The optical sheet of claim 12, wherein the prism unit includes a plurality of first beads.

18. The optical sheet of claim 12, further comprising a second protective film under the base film.

19. The optical sheet of claim 12, wherein the prism unit includes a plurality of peaks and a plurality of valleys, and a height of each peak varies randomly along a longitudinal direction on the prism unit.

20. The optical sheet of claim 12, wherein the prism unit includes a plurality of peaks and a plurality of valleys, and the peak is formed in the form of a straight line or a curved line along a longitudinal direction of the prism unit.
